(19) United States
(12) Patent Application Publication
(10) Pub. No.: US 2015/0100622 A1
(43) Pub. Date: Apr. 9, 2015

(54) Network Device Mediation

(71) Applicant: Comcast Cable Communications, LLC, Philadelphia, PA (US)

(72) Inventors: David Urban, Downingtown, PA (US); Christopher R. Albano, Medford, NJ (US)

(73) Assignee: Comcast Cable Communications, LLC, Philadelphia, PA (US)

(21) Appl. No.: 14/046,166

(22) Filed: Oct. 4, 2013

(51) Int. Cl. H04L 29/08; H04L 29/06

(52) U.S. Cl. CPC H04L 67/141; H04L 67/16; H04L 67/42
USPC 709/203

(57) ABSTRACT

Systems and methods for managing a network are disclosed. One method can comprise establishing communication with an interface of a user device, wherein the user device is located within a first network that is external to a second network. Communication can be established with a computing device, wherein the computing device is located within the second network, and wherein data is received from the computing device based at least in part on a threshold service parameter. An emulation of the interface of the user device can communicate with the computing device to satisfy the threshold service parameter.

### BACKGROUND

A network such as a local area network can comprise one or more network devices (for example, access points (APs)) to enable one or more user devices to communicate with and/or over the network. A network device can comprise a device that allows wired and/or wireless user devices to connect to a wired network using Wi-Fi, Bluetooth, or related standards. Often, wireless devices have longer ping times than wired devices. When an application server is used to determine the level of service of a wireless device and/or client application associated with the wireless device, extended ping times can cause the application server to reduce a level of service provided to the wireless device. Accordingly, improvements are needed for mediating devices connected to a network. These and other shortcomings are addressed by the present disclosure.

### SUMMARY

It is to be understood that both the following general description and the following detailed description are exemplary and explanatory only and are not restrictive, as claimed. Methods and systems for providing network services to one or more user devices or clients are described. The methods and systems described herein, in one aspect, can minimize the effects of ping time performance differences between wired and wireless devices that interact with a computing device such as an application server, for example, by leveraging spare wireless capacity between gateways and devices (e.g., clients).

In an aspect, methods can comprise establishing communication with an interface of a user device (e.g., computing device), wherein the user device is located within a first network that is external to a second network. Communication can also be established with a computing device (e.g., server, second user device, etc.), wherein the computing device is located within the second network, and wherein data is transmitted from the computing device based at least in part on a threshold service parameter. The threshold service parameter can define a level of an operational parameter required for a certain level of service. As an example, the threshold service parameter can comprise one or more of packet loss, latency, and available bandwidth. When an operational parameter associated with a particular device satisfies (e.g., exceeds a minimum threshold; is within a maximum threshold; meets a required level) a particular threshold service parameter, a level of service associated with the particular threshold service parameter can be provided to the device. In an aspect, an emulation of the interface of the user device can be provided. The emulated interface of the user device can communicate with the computing device to satisfy the threshold service parameter.

In another aspect, methods can comprise establishing communication with an interface of a user device. The user device can be located within a first network that is external to a second network. Communication with a computing device can also be established. The computing device can be located within the second network. Data can be received from the computing device. The data can be transmitted from the computing device based at least in part on a threshold service parameter. The threshold service parameter can define a level of an operational parameter required for a certain level of service. As an example, the threshold service parameter can comprise one or more of packet loss, latency, and available bandwidth. When an operational parameter associated with a particular device satisfies (e.g., exceeds a minimum threshold; is within a maximum threshold; meets a required level) a particular threshold service parameter, a level of service associated with the particular threshold service parameter can be provided to the device. If the detected service parameter does not satisfy (e.g., exceed a minimum threshold; is within a maximum threshold; meet a required level) the threshold service parameter, transmission of the data to the interface of the user device can be modified to facilitate satisfaction of the threshold service parameter.

In a further aspect, a network can comprise a user device having an interface in communication with a network device. The network can comprise a computing device in communication with the network device. Data can be transmitted from the computing device based at least in part on a threshold service parameter. The network device can be configured to emulate the interface of the user device. The emulated interface of the user device can communicate with the computing device to satisfy the threshold service parameter.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary system and network;

FIG. 2 is a block diagram of an exemplary computing device;

FIG. 3 is a block diagram of an exemplary system and network;

FIG. 4 is a block diagram of an exemplary system and network;

FIG. 5 is a flow chart of an exemplary method;

FIG. 6 is a flow chart of an exemplary method; and

FIG. 7 is a flow chart of an exemplary method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded on a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems described herein, in one aspect, can minimize the effects of ping time performance differences between wired and wireless devices that interact with a computing device such as an application server, for example, by leveraging spare wireless capacity between gateways and devices (e.g., clients). In an aspect, a poor ping time between the wireless device and the computing device or a gateway may disqualify a wireless device from receiving a particular service level. However, the gateway may have spare capacity that can be used to maintain performance at the particular service level independent of ping time. Accordingly, the computing device can allow the wireless device to receive the particular service level in spite of the poor ping time.

Certain computing devices (e.g., application servers) can determine the level of service (e.g., high definition, standard definition, etc.) to offer to a user device (e.g., client) based on one or more parameters associated with the user device and/or a network in communication with the user device. In another aspect, the level of service offered to the user device can be boosted or improved by mediating the application server at a network device, such as a gateway or access point. As an example, the network device can mediate parameters associated with the user device in order to cause the computing device to provide a particular level of service (e.g., an improved level of service). Such mediation can comprise providing faux (e.g., artificial) parameter measurements to a service provider (e.g., computing device associated with a service provider) in order to satisfy a required threshold service parameter. The faux parameter can be processed by the service provider in order to assign a particular level of service to one or more devices. As such, a level of service can be attained by one or more devices, even if the one or more devices do not actually satisfy the threshold requirement of attaining the level of service.

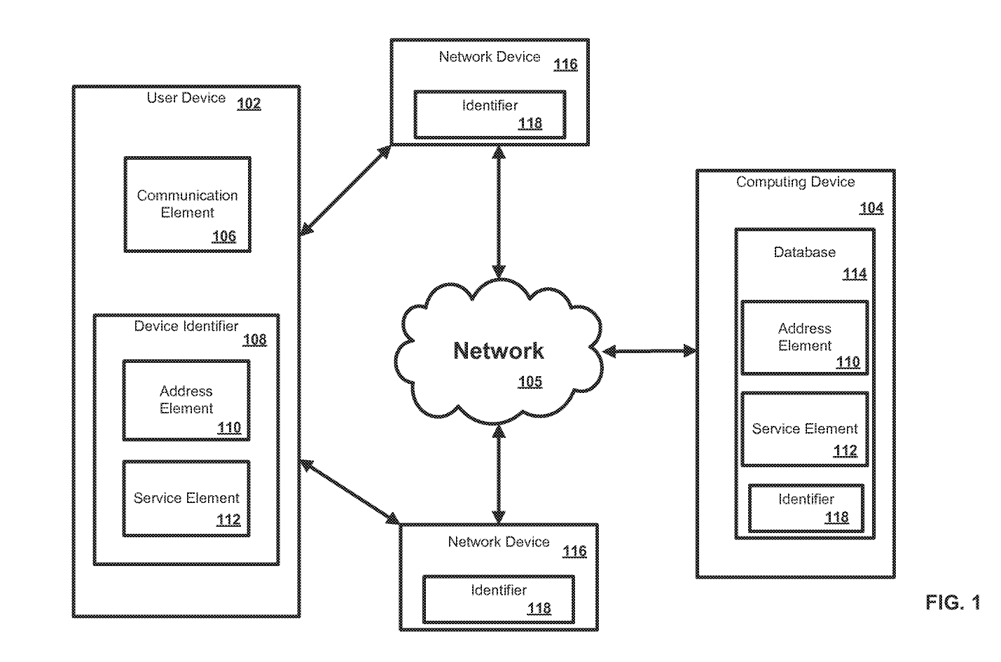

In one aspect of the disclosure, a system can be configured to provide services such as network-related services. FIG. 1 illustrates various aspects of an exemplary environment in which the present methods and systems can operate. The present disclosure is relevant to systems and methods for providing services to a user device, for example. Those skilled in the art will appreciate that present methods may be used in various types of networks and systems that employ both digital and analog equipment. One skilled in the art will appreciate that provided herein is a functional description and that the respective functions can be performed by software, hardware, or a combination of software and hardware.

The network and system can comprise a user device 102 in communication with a computing device 104 such as a server, for example. The computing device 104 can be disposed locally or remotely relative to the user device 102. As an example, the user device 102 and the computing device 104 can be in communication via a private and/or public network 105 such as the Internet. Other forms of communications can be used such as wired and wireless telecommunication channels, for example.

In an aspect, the user device 102 can be an electronic device such as a computer, a smartphone, a laptop, a tablet, a set top box, a display device, or other device capable of communicating with the computing device 104. As an example, the user device 102 can comprise a communication element 106 for providing an interface to a user to interact with the user device 102 and/or the computing device 104. The communication element 106 can be any interface for presenting information to the user and receiving a user feedback such as an application client or a web browser (e.g., Internet Explorer, Mozilla Firefox, Google Chrome. Safari, or the like). As an example, a client application can be or comprise a computer program that enables real time data exchange between the user device 102 and the computing device 104. Client applications can include applications facilitating video calling, streaming video, file download, or live multi-location music sessions. Other software, hardware, and/or interfaces can be used to provide communication between the user and one or more of the user device 102 and the computing device 104. As an example, the communication element 106 can request or query various files from a local source and/or a remote source. As a further example, the communication element 106 can transmit data to a local or remote device, such as the computing device 104.

In an aspect, the user device 102 can be associated with a user identifier or device identifier 108. As an example, the device identifier 108 can be any identifier, token, character, string, or the like, for differentiating one user or user device (e.g., user device 102) from another user or user device. In a further aspect, the device identifier 108 can identify a user or user device as belonging to a particular class of users or user devices. As a further example, the device identifier 108 can comprise information relating to the user device such as a manufacturer, a model or type of device, a service provider associated with the user device 102, a state of the user device 102, a locator, and/or a label or classifier. Other information can be represented by the device identifier 108.

In an aspect, the device identifier 108 can comprise an address element 110 and a service element 112. In an aspect, the address element 110 can be an internet protocol address, a network address, an Internet address, or the like. As an example, the address element 110 can be relied upon to establish a communication session between the user device 102 and the computing device 104 or other devices and/or networks. As a further example, the address element 110 can be used as an identifier or locator of the user device 102. In an aspect, the address element 110 can be persistent for a particular network.

In an aspect, the service element 112 can comprise an identification of a service provider associated with the user device 102 and/or with the class of user device 102. As an example, the service element 112 can comprise information relating to or provided by a communication service provider (e.g., Internet service provider) that is providing or enabling communication services to the user device 102. As a further example, the service element 112 can comprise information relating to a preferred service provider for one or more particular services relating to the user device 102. In an aspect, the address element 110 can be used to identify or retrieve the service element 112, or vise versa. As a further example, one or more of the address element 110 and the service element 112 can be stored remotely from the user device 102 and retrieved by one or more devices such as the user device 102 and the computing device 104. Other information can be represented by the service element 112.

In an aspect, the computing device 104 can be a server for communicating with the user device 102. As an example, the computing device 104 can communicate with the user device 102 for providing services. In an aspect, the computing device 104 can allow the user device 102 to interact with remote resources, such as data, devices, and files. As an example, the computing device can be configured as a central location (e.g., a headend, or processing facility) which can receive content (e.g., data, input programming) from multiple sources. The computing device 104 can combine the content from the various sources and can distribute the content to user (e.g., subscriber) locations via a distribution system.

In an aspect, the computing device 104 can manage the communication between the user device 102 and a database 114 for sending and receiving data therebetween. As an example, the database 114 can store a plurality of files (e.g., web pages), user identifiers or records, or other information. As a further example, the user device 102 can request and/or retrieve a file from the database 114. In an aspect, the database 114 can store information relating to the user device 102, such as the address element 110 and/or the service element 112. As an example, the computing device 104 can obtain the device identifier 108 from the user device 102 and retrieve information from the database 114, such as the address element 110 and/or the service elements 112. As a further example, the computing device 104 can obtain the address element 110 from the user device 102 and can retrieve the service element 112 from the database 114, or vice versa. Any information can be stored in and retrieved from the database 114. The database 114 can be disposed remotely from the computing device 104 and can be accessed via direct or indirect connection. The database 114 can be integrated with the computing system 104 or some other device or system.

In an aspect, one or more network devices 116 can be in communication with a network such as network 105. As an example, one or more of the network devices 116 can facilitate the connection of a device, such as user device 102, to the network 105. As a further example, one or more of the network devices 116 can be configured as a network gateway. In an aspect, one or more network devices 116 can be configured to allow one or more wireless devices to connect to a wired and/or wireless network using Wi-Fi, Bluetooth or similar standard.

In an aspect, the network devices 116 can be configured as a mesh network. As an example, one or more network devices 116 can comprise a dual band wireless network device. As an example, the network devices 116 can be configured with a first service set identifier (SSID) (e.g., associated with a user network or private network) to function as a local network for a particular user or users. As a further example, the network devices 116 can be configured with a second service set identifier (SSID) (e.g., associated with a public/community network or a hidden network) to function as a secondary network or redundant network for connected communication devices.

In an aspect, one or more network devices 116 can comprise an identifier 118. As an example, one or more identifiers can be a media access control address (MAC address). As a further example, one or more identifiers 118 can be a unique identifier for facilitating communications on the physical network segment. In an aspect, each of the network devices 116 can comprise a distinct identifier 118. As an example, the identifiers 118 can be associated with a physical location of the network devices 116.

In an aspect, in the OSI reference model, a layer 2 connection can be provided to facilitate the connectivity of one or more user devices 102 and one or more network devices 116 of a network. In an aspect, in the OSI reference model, a layer 2 connection can be provided to facilitate the connectivity of one or more computing devices 104 and one or more network devices 116 of a network.

In an aspect, the user device 102 can have an interface (communication element 106) in communication with a network device, such as network device 116. In another aspect, the user device 102 can be located within a first network (e.g., LAN, WLAN, etc.) that is external to a second network (e.g., wide area network, Internet, etc.) As an example, the interface of the user device 102 can comprise an application client. The first network can be or comprise a wireless local area network using a short range unlicensed spectrum. The first network can have a higher data transmission speed than the second network. The second network can be a wired metropolitan area network that has very high reliability, since it is a wired network managed by a service provider.

In an aspect, the computing device 104 can be in communication with a network device such as network device 116. As an example, the computing device 104 can be or comprise an application server. In another aspect, the computing device 104 is located within the second network. In a further aspect, data can be transmitted from the computing device 104 based at least in part on a threshold service parameter, such as packet loss, latency, and available bandwidth.

In an aspect, the network device 116 can be configured to emulate the interface of the user device 102. As an example, the emulated interface can be configured to communicate with the computing device 104 to satisfy the threshold service parameter. In another aspect, the emulated interface can comprise a faux application client in communication with the network device 116. As another example, the network device 116 can comprise a faux application server configured to communicate with the faux application client of the user device 102. In a further aspect, the network device 116 can be configured to modify transmission of data to the interface of the user device 102 to facilitate satisfaction of the threshold service parameter. As an example, a measurable parameter can be artificially modified in order to satisfy the threshold service parameter. As a further example, the artificially modified parameter can comprise one or more of an available bandwidth, packet loss, and latency. Such artificial modification can comprise retransmission of packets to lower the packet loss measurement.

As an example, a telephony service, such as an IP video calling service, can provide high definition (HD) video to one or more user devices based on quality parameters, such as latency and packet loss. As another example, packet loss less than 1% and latency of 20 ms or less can qualify a user device for HD video. When the client does not satisfy these criteria, the video quality falls back to standard definition (SD). When a client device meets just the level 1 criteria (SD quality), a network device, such as a gateway, can mediate to boost the possibilities of the client to satisfy level 2 criteria (HD quality). Mediation can comprise retransmission of packets, ACK retransmission, parity, and the like. Mediation can generate a faux parameter, such as low latency and packet loss. Accordingly, service criteria or thresholds can be met using mediation rather than actual parameter detection.

As an example, HD Quality IP Video telephony can require about 1.5 Mbps downstream and upstream bandwidth. At a steady bandwidth of 1.5 Mbps, a packet can be transmitted about every 10 milliseconds. On the local Wi-Fi network, a network device such as a gateway (e.g., operating a 802.11g or 802.11n network) can offer theoretical bandwidths ranging from 54 Mbps up to 600 Mbps. Assuming a low bandwidth of about 39 Mbps between the gateway and the client, the time required to transmit one packet of 1510 bytes takes about 504 microseconds. To satisfy the IP telephony bandwidth requirement, it is enough to transmit a packet every 10 millisecond while the capability is 0.5 milliseconds. This means that there are 10 ms/0.5 ms=20 time slices available, one of which is used to transmit a single packet. The rest of the 19 time slices can be utilized to send multiple copies of the same packet to ensure the packet is delivered without loss. As copies of the same packet are transmitted more often than required, the low latency requirement can be achieved. Repetition is one method of utilizing excess data rate capability in the first network in order to correct for less than satisfactory reliability. Other methods include forward error correction techniques, such a parity check coding, interleaving, and automatic repeat request.

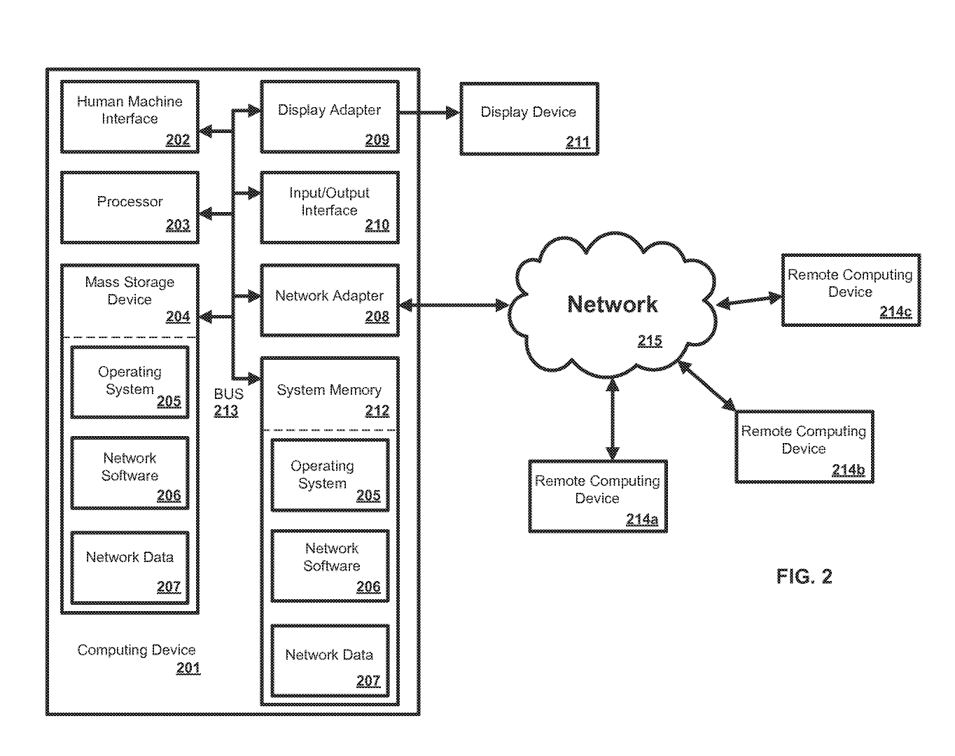

In an exemplary aspect, the methods and systems can be implemented on a computing system such as computing device 201 as illustrated in FIG. 2 and described below. By way of example, one or more of the user device 102 and the computing device 104 of FIG. 1 can be a computer as illustrated in FIG. 2. Similarly, the methods and systems disclosed can utilize one or more computers to perform one or more functions in one or more locations. FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 201. The components of the computing device 201 can comprise, but are not limited to, one or more processors or processing units 203, a system memory 212, and a system bus 213 that couples various system components including the processor 203 to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, network software 206, network data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The computing device 201 typically comprises a variety of computer readable media. Exemplary readable media can be any available media that is accessible by the computing device 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as network data 207 and/or program modules such as operating system 205 and network software 206 that are immediately accessible to and/or are presently operated on by the processing unit 203.

In another aspect, the computing device 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computing device 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and network software 206. Each of the operating system 205 and network software 206 (or some combination thereof) can comprise elements of the programming and the network software 206. Network data 207 can also be stored on the mass storage device 204. Network data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computing device 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computing device 201 can have more than one display adapter 209 and the computer 201 can have more than one display device 211. For example, a display device can be a monitor, an LCD (Liquid Crystal Display), or a projector. In addition to the display device 211, other output peripheral devices can comprise components such as speakers (not shown) and a printer (not shown) which can be connected to the computing device 201 via Input/Output Interface 210. Any step and/or result of the methods can be output in any form to an output device. Such output can be any form of visual representation, including, but not limited to, textual, graphical, animation, audio, tactile, and the like. The display 211 and computing device 201 can be part of one device, or separate devices.

The computing device 201 can operate in a networked environment using logical connections to one or more remote computing devices 214a,b,c. By way of example, a remote computing device can be a personal computer, portable computer, a smart phone, a server, a router, a network computer, a peer device or other common network node, and so on. Logical connections between the computing device 201 and a remote computing device 214a,b,c can be made via a network 215, such as a local area network (LAN) and a general wide area network (WAN). Such network connections can be through a network adapter 208. A network adapter 208 can be implemented in both wired and wireless environments. Such networking environments are conventional and commonplace in dwellings, offices, enterprise-wide computer networks, intranets, and the Internet.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of network software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology. CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

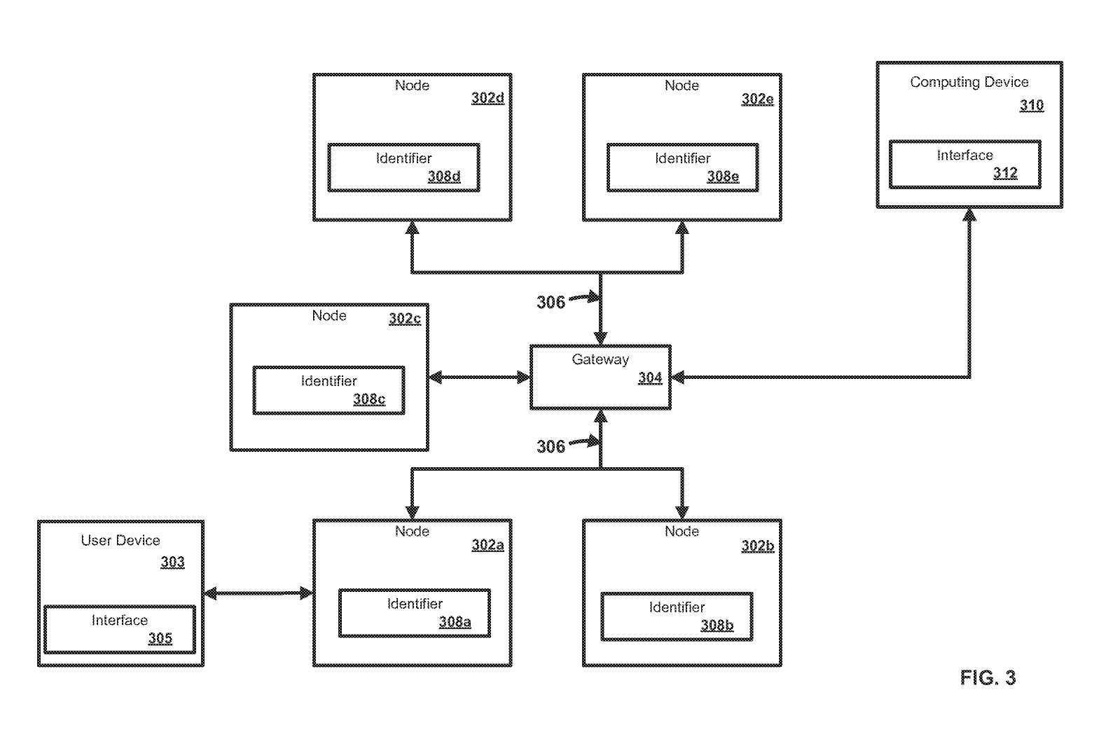

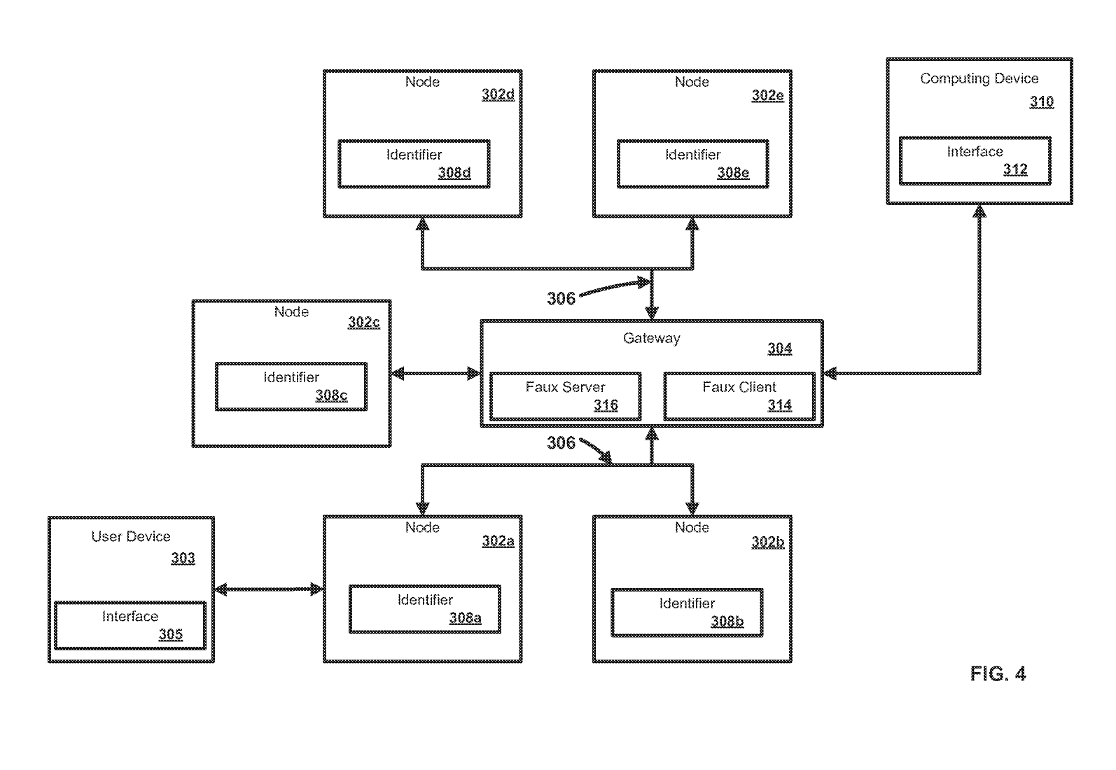

FIGS. 3-4 illustrate an exemplary system and network. In an aspect, a plurality of nodes 302a, 302b, 302c, 302d, 302e can be in communication with one or more user devices 303 and a gateway 304. As an example, one or more nodes 302a, 302b, 302c, 302d, 302e can be a network device, router, switch, communication device, or the like. As another example, one or more user devices 303 can be an electronic device such as a computer, a smartphone, a laptop, a tablet, a set top box, a display device, or other device capable of communicating with one or more of the nodes 302a, 302b, 302c, 302d, 302e of the network.

In an aspect, the user device 303 can have an interface 305 (application client) in communication with a network device such as one or more nodes 302a, 302b, 302c, 302d, 302e and/or the gateway 304. In another aspect, the user device 303 can be located within a first network (e.g., LAN, WLAN, etc.) that is external to a second network (e.g., wide area network, Internet, etc.). As an example, the interface of the user device 303 can comprise an application client.

In an aspect, one or more of the nodes 302a, 302b, 302c, 302d, 302e can be configured to communicate with another of the nodes 302a, 302b, 302c, 302d, 302e and/or the gateway 304 via one or more communication paths 306. In an aspect, the one or more communication paths 306 can comprise one or more uninterrupted communication links, sequential links, pre-defined paths or links, and/or intervening nodes. Links can comprise a single point to point connection between two devices or network devices. Paths can comprise one or more links. As an example, one or more of the communication paths can comprise one or more of the nodes 302a, 302b, 302c, 302d, 302e. As a further example, one or more of the nodes 302a, 302b, 302c, 302d, 302e can be configured as a mesh network. In an aspect, one ore more of the communication paths 306 can be configured to transmit one or more services.

In an aspect, one or more of the nodes 302a, 302b, 302c, 302d, 302e can comprise an identifier 308a, 308b, 308c, 308d, 308e. As an example, one or more identifiers can be a media access control address (MAC address). Any uniquely identifiable attribute that can be linked to a location can be used as the identifier 308a, 308b, 308c, 308d, 308e. Such attributes can comprise one or more of an IP Address, serial number, latitude/longitude, geo-encoding, custom assigned unique identifier, global unique identifier (GUID), and the like. As a further example, one or more identifiers 308a, 308b, 308c, 308d, 308e can be a unique identifier for facilitating communications on the physical network segment. In an aspect, each of the nodes 302a, 302b, 302c, 302d, 302e can comprise a distinct identifier 308. As an example, the identifiers 308a, 308b, 308c, 308d, 308e can be associated with a physical location of the nodes 302a, 302b, 302c, 302d, 302e.

In an aspect, a computing device 310 can be in communication with a network device such as gateway 304. As an example, the computing device 310 can be or comprise an application server. In another aspect, the computing device 310 is located within the second network. In a further aspect, data can be transmitted from the computing device 310 based at least in part on a threshold service parameter such as packet loss, latency, and available bandwidth.

As shown in FIG. 4, the gateway 304 can be configured to emulate the interface 305 of the user device 303. As an example, the emulation of the interface of the user device 303 can be configured to communicate with the computing device 310 to satisfy the threshold service parameter. In another aspect, the emulation of the interface of the user device 303 can comprise a faux application client 314 configured to communicate with the interface 312 of the computing device 310. As another example, the gateway 304 can comprise a faux application server 316 configured to communicate with the interface 305 of the user device 303. In a further aspect, the gateway 304 can be configured to modify transmission of data from the interface 312 of the computing device 310 to the interface 305 of the user device 303 to facilitate satisfaction of the threshold service parameter. As an example, a measurable parameter can be artificially modified in order to satisfy the threshold service parameter. As a further example, the artificially modified parameter can comprise one or more of an available bandwidth, packet loss, and latency. Such artificial modification can comprise retransmission of packets to lower the packet loss measurement.

As an example, a telephony service such as an IP video calling service can provide high definition (HD) video to one or more user devices based on quality parameters, such as latency and packet loss. As another example, packet loss less than 1% and latency of 20 ms or less can qualify a user device for HD video. When the client does not satisfy these criteria, the video quality falls back to standard definition (SD). When a client device meets just the level 1 criteria (SD quality), a network device such as a gateway can mediate to boost the possibilities of the client to satisfy level 2 criteria (HD quality). Mediation can comprise retransmission of packets, ACK retransmission, parity, and the like. Mediation can generate a faux parameter such as low latency and packet loss. Accordingly, service criteria or thresholds can be met using mediation rather than actual parameter detection.

As an example, HD Quality IP Video telephony can require about 1.5 Mbps downstream and upstream bandwidth. At a steady bandwidth of 1.5 Mbps, a packet can be transmitted about every 10 milliseconds. On the local Wi-Fi network, a network device such as a gateway (e.g., operating a 802.11g or 802.11n network) can offer theoretical bandwidths ranging from 54 Mbps up to 600 Mbps. Assuming a low bandwidth of about 39 Mbps between the gateway and the client, the time required to transmit one packet of 1510 bytes takes about 504 microseconds. To satisfy the IP telephony bandwidth requirement, it is enough to transmit a packet every 10 millisecond while the capability is 0.5 milliseconds. This means that there are 10 ms/0.5 ms=20 time slices available, one of which is used to transmit a single packet. The rest of the 19 time slices can be utilized to send multiple copies of the same packet to ensure the packet is delivered without loss. As copies of the same packet are transmitted more often than required, the low latency requirement can be achieved.

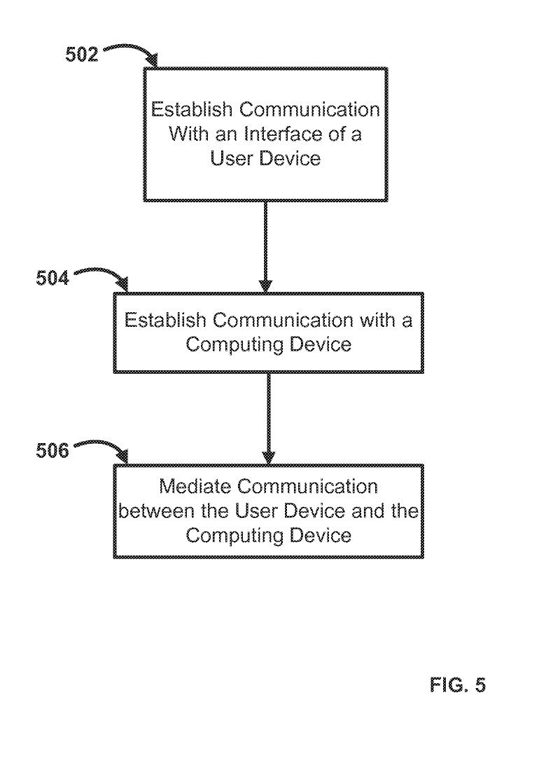

In an aspect, methods for managing location information in a network are described. An exemplary method is shown in FIG. 5. In step 502, communication can be established with a user device such as an interface (e.g., application client) associated with the user device. Establishing communication can comprise transmitting data, receiving data, providing a communication pathway or channel, providing a communication session, and the like. In an aspect, communication can be established between the user device and a network device such as a gateway. In another aspect, the user device is located within a first network (e.g., LAN) that is external to a second network (e.g., WAN).

In step 504, communication can be established with a computing device. The computing device can be located within the second network. Establishing communication can comprise transmitting data, receiving data, providing a communication pathway or channel, providing a communication session, and the like. In an aspect, communication can be established between the computing device and a network device such as a gateway. Establishing communication can comprise transmitting data from the computing device based at least in part on a threshold service parameter. As an example, the threshold service parameter can comprise one or more of packet loss, latency, and available bandwidth.

In step 506, communication between the user device and the computing device can be mediated. In an aspect, the computing device and the user device can communicate with a network device and the network device can mediate information between the user device and the computing device. Mediation can comprise establishing communication between the computing device and a faux application client and establishing communication between the interface of the user device and a faux application server.

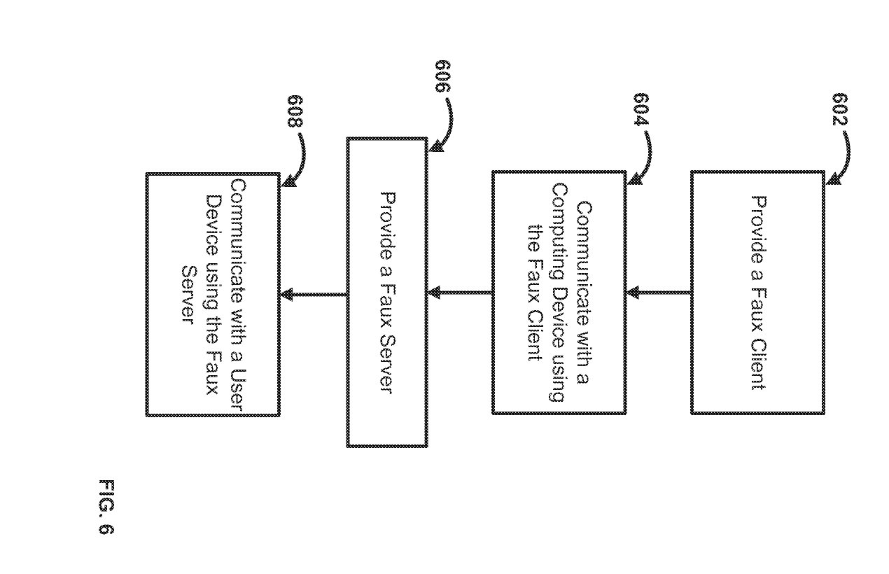

An exemplary method is shown in FIG. 6. In step 602, a faux client (e.g., application client) can be provided. In an aspect, the faux client can be implemented by a network device, such as a gateway. In a further aspect, the faux client can be an emulation of an interface of a user device in communication with the network device.

In step 604, communication can be established with a computing device. In an aspect, the faux client can communicate with the computing device. Communication can comprise transmitting data, receiving data, providing a communication pathway or channel, providing a communication session, and the like.

In step 606, a faux server (e.g., application server) can be provided. In an aspect, the faux server can be implemented by a network device such as a gateway. In a further aspect, the faux server can be an emulation of an interface of a computing device in communication with the network device.

In step 608, communication can be established with a user device. In an aspect, the faux server can communicate with the user device. Communication can comprise transmitting data, receiving data, providing a communication pathway or channel, providing a communication session, and the like. In another aspect, communication between the user device and the computing device can be mediated. In an aspect, the computing device and the user device can communicate with the network device, and the network device can mediate information between the user device and the computing device using the faux client. Mediation can comprise establishing communication between the computing device and a faux application client and establishing communication between the interface of the user device and a faux application server. As an example, the network device can mediate parameters associated with the user device in order to cause the computing device to provide a particular level of service (e.g., an improved level of service).

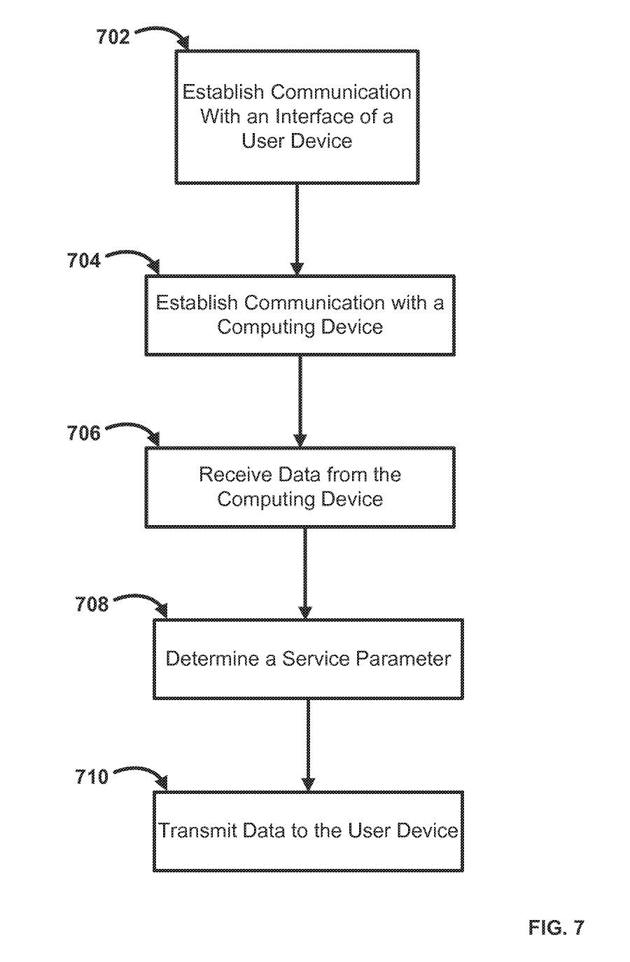

An exemplary method is shown in FIG. 7. In step 702, communication can be established with a user device, such as an interface (e.g., application client) associated with the user device. Establishing communication can comprise transmitting data, receiving data, providing a communication pathway or channel, providing a communication session, and the like. In an aspect, communication can be established between the user device and a network device such as a gateway. In another aspect, the user device is located within a first network (e.g., LAN) that is external to a second network (e.g., WAN).

In step 704, communication can be established with a computing device. The computing device can be located within the second network. Establishing communication can comprise transmitting data, receiving data, providing a communication pathway or channel, providing a communication session, and the like. In an aspect, communication can be established between the computing device and a network device, such as a gateway. Establishing communication can comprise transmitting data from the computing device based at least in part on a threshold service parameter. As an example, the threshold service parameter can comprise one or more of packet loss, latency, and available bandwidth.

In step 706, data can be received from the computing device. In an aspect, data can be received by the network device (e.g., a faux client on the network device). In a further aspect, the data can be received from the computing device based at least in part on a threshold service parameter. As an example, the threshold service parameter can comprise one or more of packet loss, latency, and available bandwidth.

In step 708, a service parameter can be determined. As an example, the threshold service parameter can comprise one or more of packet loss, latency, and available bandwidth. If the detected service parameter does not satisfy the threshold service parameter, transmission of the data to the user device can be modified to facilitate satisfaction of the threshold service parameter. Such modification can comprise retransmission of packets and/or transmission of multiple copies of a packet. In step 710, data can be transmitted to the user device.

As an example, a telephony service such as an IP video calling service can provide high definition (HD) video to one or more user devices based on quality parameters, such as latency and packet loss. As another example, packet loss less than 1% and latency of 20 ms or less can qualify a user device for HD video. When the client does not satisfy these criteria, the video quality falls back to standard definition (SD). When a client device meets just the level 1 criteria (SD quality), a network device such as a gateway can mediate to boost the possibilities of the client to satisfy level 2 criteria (HD quality). Mediation can comprise retransmission of packets, ACK retransmission, parity, and the like. Mediation can generate a faux parameter such as low latency and packet loss. Accordingly, service criteria or thresholds can be met using mediation rather than actual parameter detection.

As an example, HD Quality IP Video telephony can require about 1.5 Mbps downstream and upstream bandwidth. At a steady bandwidth of 1.5 Mbps, a packet can be transmitted about every 10 milliseconds. On the local Wi-Fi network, a network device such as a gateway (e.g., operating a 802.11g or 802.11n network) can offer theoretical bandwidths ranging from 54 Mbps up to 600 Mbps. Assuming a low bandwidth of about 39 Mbps between the gateway and the client, the time required to transmit one packet of 1510 bytes takes about 504 microseconds. To satisfy the IP telephony bandwidth requirement, it is enough to transmit a packet every 10 millisecond while the capability is 0.5 milliseconds. This means that there are 10 ms/0.5 ms=20 time slices available, one of which is used to transmit a single packet. The rest of the 19 time slices can be utilized to send multiple copies of the same packet to ensure the packet is delivered without loss. As copies of the same packet are transmitted more often than required, the low latency requirement can be achieved.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
establishing communication with an interface of a user device, wherein the user device is located within a first network that is external to a second network;
establishing communication with a computing device, wherein the computing device is located within the second network, and wherein data is received from the computing device based at least in part on a threshold service parameter; and
emulating the interface of the user device, wherein the emulation of the interface of the user device communicates with the computing device to satisfy the threshold service parameter.

2. The method of claim 1, wherein the interface of the user device comprises an application client and the computing device comprises an application server.

3. The method of claim 1, wherein the first network comprises a local area network.

4. The method of claim 1, wherein the second network comprises a wide area network.

5. The method of claim 1, wherein the threshold service parameter comprises one or more of packet loss, latency, and available bandwidth.

6. The method of claim 1, wherein emulating the interface of the user device comprises establishing communication between the computing device and a faux application client, and establishing communication between the interface of the user device and a faux application server.

7. The method of claim 1, wherein satisfying the threshold service parameter comprises modifying transmission of data from the emulation of the interface to the interface of the user device to facilitate satisfaction of the threshold service parameter

8. A method comprising:
establishing communication with an interface of a user device, wherein the user device is located within a first network that is external to a second network;
establishing communication with a computing device, wherein the computing device is located within the second network;
receiving data from the computing device, wherein the data is received from the computing device based at least in part on a threshold service parameter;
detecting a service parameter associated with the communication with the interface of the user device; and
if the detected service parameter does not satisfy the threshold service parameter, modifying transmission of the data to the interface of the user device to facilitate satisfaction of the threshold service parameter.

9. The method of claim 8, wherein the interface of the user device comprise an application client.

10. The method of claim 8, wherein the first network comprises a local area network.

11. The method of claim 8, wherein the computing device comprises an application server.

12. The method of claim 8, wherein the second network comprises a wide area network.

13. The method of claim 8, wherein one or more of the service parameter and the threshold service parameter comprise one or more of packet loss, latency, and available bandwidth.

14. The method of claim 8, wherein modifying transmission comprises executing forward error correction.

15. A network comprising:
a user device having an interface in communication with a network device, wherein the user device is located within a first network that is external to a second network; and
a computing device in communication with the network device, wherein the computing device is located within the second network, and wherein data is transmitted from the computing device based at least in part on a threshold service parameter, and wherein the network device is configured to emulate the interface of the user device, wherein the emulation of the interface of the user device communicates with the computing device to satisfy the threshold service parameter.

16. The network of claim 15, wherein the interface of the user device comprises an application client, and the computing device comprises an application server.

17. The network of claim 15, wherein the first network comprises a local area network and the second network comprises a wide area network.

18. The network of claim 15, wherein the threshold service parameter comprises one or more of packet loss, latency, and available bandwidth.

19. The network of claim 15, wherein the emulation of the interface of the user device comprises a faux application client in communication with the computing device, and a faux application server in communication with the interface of the user device.

20. The network of claim 15, wherein the network device is further configured to modify transmission of data to the interface of the user device to facilitate satisfaction of the threshold service parameter.
